(19) United States
(12) Patent Application Publication
(10) Pub. No.: US 2008/0071677 A1
(43) Pub. Date: Mar. 20, 2008

(54) Method for retail financing

(76) Inventor: Alexander Virgil Williams, Asheville, NC (US)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(21) Appl. No.: 11/903,283

(22) Filed: Sep. 20, 2007

Related U.S. Application Data
(60) Provisional application No. 60/846,287, filed on Sep. 20, 2006.

(51) Int. Cl. G06Q 40/00

(52) U.S. Cl. 705/38

(57) ABSTRACT

There is provided a method for retail financing. A financing entity provides at least one unit to be financed to a retailer. The retailer collects information concerning a customer who desires to purchase the unit. The customer information is forwarded to the financing entity. The financial terms and conditions, including down payment and monthly payments, are prepared. The sale of the unit to the customer is approved. The down payment is collected from the customer. The terms and conditions are executed by the customer. The unit is delivered to the customer and the financing entity pays the dealer a portion of the down payment and a portion of the monthly payments.

### RELATIONSHIP TO PRIOR APPLICATIONS

This is a U.S. non-provisional application relating to and claiming the benefit of U.S. Provisional Patent Application Ser. No. 60/846,287, filed Sep. 20, 2006.

### BACKGROUND

This invention relates to a new method of retail financing which is applicable to any consumer product which requires financing but is particularly applicable to the sale of vehicles, such as power sports vehicles.

### BRIEF DESCRIPTION OF THE DRAWINGS

FIG. 1 is a flow chart illustrating one embodiment of the subject invention.

FIG. 2 is a flow chart illustrating another embodiment of the invention.

FIG. 3 is another flow chart illustrating yet another embodiment of the invention.

### DESCRIPTION OF PREFERRED EMBODIMENTS

The method combines a guaranteed financing program with a commission payment to and preferably a consignment agreement with dealers to form the Retail Financing Program. The Retail Financing Program offers guaranteed financing to anyone of legal age that can prove residency and income. This, alone, allows for exponentially increased sales by simply opening the power sports market to a segment previously ignored by other manufacturers and distributors. By utilizing existing dealer infrastructure, the manufacturer or the distributor and the independent dealer can maximize sales potential by combining the best of both worlds, name brand advertising recognition and guaranteed financing. Over 60% of potential sales are lost simply because of credit issues. This equals lost sales for the dealer and ultimately the manufacturer. The power sports industry has been saddled with this problem with no solution in sight, until now. The Retail Financing Program is the answer.

The Retail Financing Program has three preferred levels of participation, as set forth below. As used herein, the term “distributor” can be either a manufacturer or a distributor. The financing entity must be either a manufacturer, a distributor, or another entity which supplies units such as vehicles to dealers.

Gold Level: Inventory of units, such as vehicles, is placed at the independent dealer and ownership is maintained by the manufacturer or distributor which is also the financing entity. The Retail Financing Program utilizes the following:
1. Dealer takes customer's information and completes credit application.
2. Application is submitted to the distributor by phone, fax, or online web site.
3. The distributor's approvals manager approves the sale, designating vehicle model, down payment, loan term, and monthly payments through an online approval system known as ‘BOS.’
4. Dealer completes sale and collects down payment and customer signatures on all applicable paperwork, and delivers the vehicle.
5. Sale is completed automatically online through BOS, signed paperwork is mailed to the distributor, and down payment collected is deposited in the distributor's depository account.
6. Once down payment has been confirmed to be deposited and paperwork has been received, the contract is then executed and collected by the distributor.
7. A flat fee is paid to the dealer by the distributor for every sale.
8. As monthly payments are received, the distributor pays the dealer its share or commission of that monthly payment through the term of the loan.

This Retail Financing Program differs from traditional lending in the following ways:
1. The distributor, as the lender, provides inventory for sale and maintains the ownership of vehicles until time of sale and remains the lien holder through the term of the loan.
2. The distributor, as the lender, does not pay the retail price of the vehicle to the dealer at time of sale. Rather, the distributor pays the dealer a portion of the total contract value, including administrative fees, freight, sales tax, and interest as the customer makes payments.

The distributor does all collections and will repossess or take the customer to court to recover money lost due to bad debt contracts. In the event that this occurs, any monies collected from customer through suit will be applied to the customer's account and the dealer's portion paid out to the dealer. If the vehicle is repossessed and can be refitted for sale, the dealer will provide labor, the distributor will provide parts and the vehicle will be resold. If the vehicle is resold for cash, the sale price of the vehicle is split 50/50 between the dealer and the distributor. If the vehicle is sold as a financed vehicle, the standard contract terms will apply for payout.

Silver Level: The distributor may offer this partnership program for smaller sized dealers with less sales volume and different terms, but still the same capability to take advantage of the Retail Financing Program.

The Silver Level differs from the Gold Level primarily in that a requirement for participation by the dealer is a purchase of preferably at least 10 vehicles by the dealer and an inventory of a certain number of vehicles, such as 10, at all times. A vehicle in dealer's inventory can be sold under the Retail Financing Program, but the dealer must purchase another vehicle from the distributor to replace the sold vehicle in inventory.

Silver Level dealers are required to transfer all monies collected by the customer to the distributor in the form of certified check or money order. Silver Level dealers are not required to take monthly payments nor have a depository account setup.

Bronze Level: The final tiered offering from the distributor is the Bronze Level. This allows for any dealer to participate on a very limited basis. This method only requires that the dealer forward the distributor their rejected credit applications for its review, and upon completed sale, the distributor will pay the dealer a flat fee and no portion of the monthly payments.

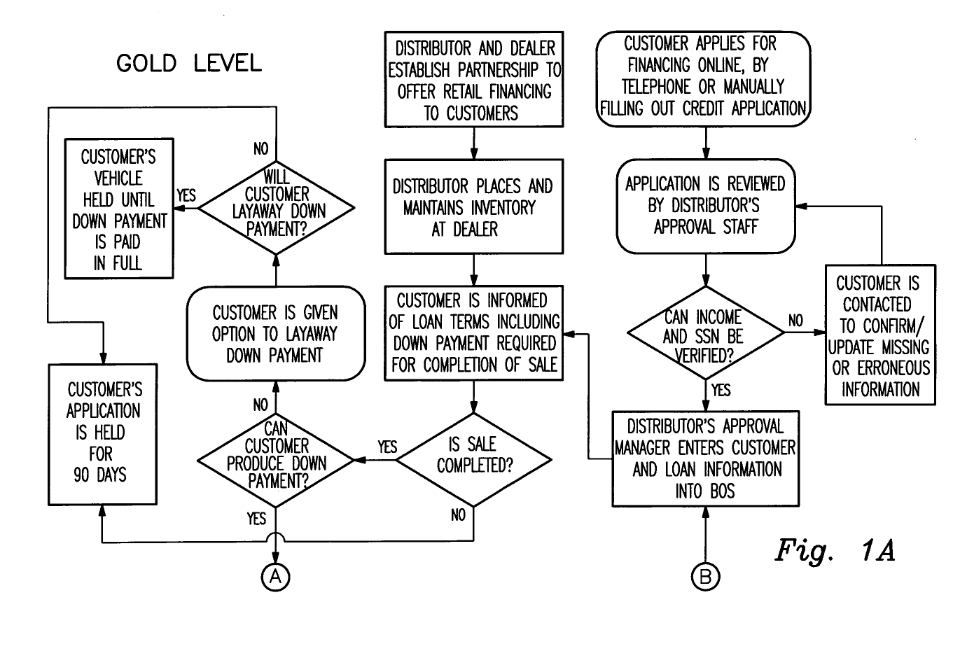

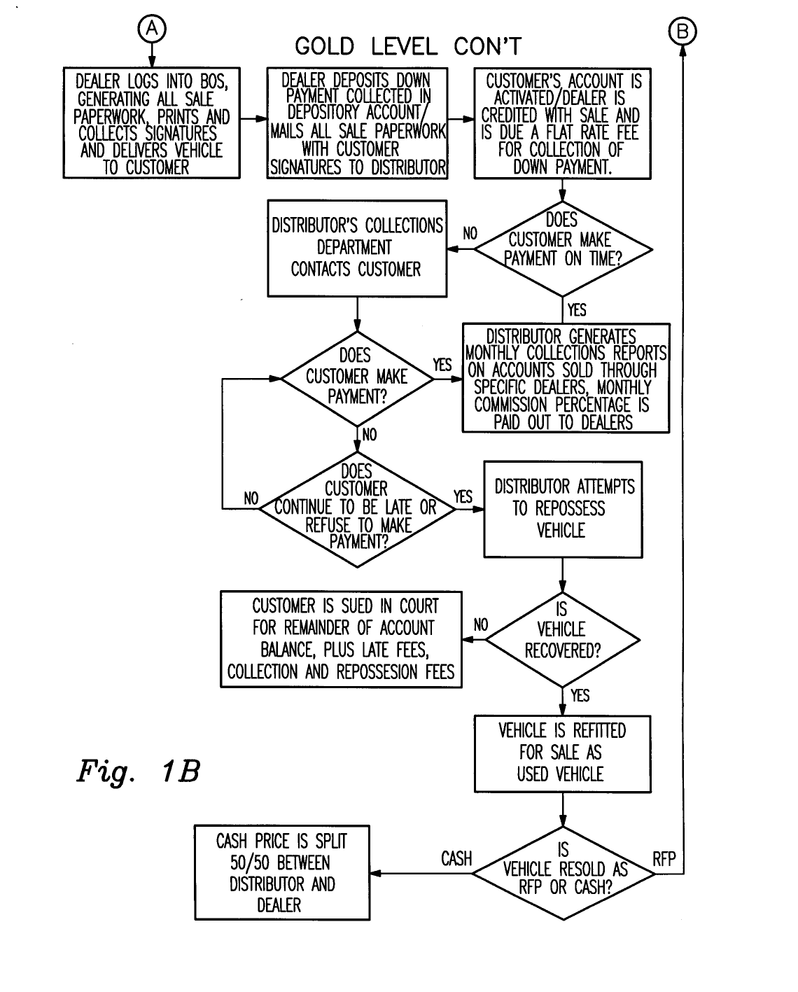

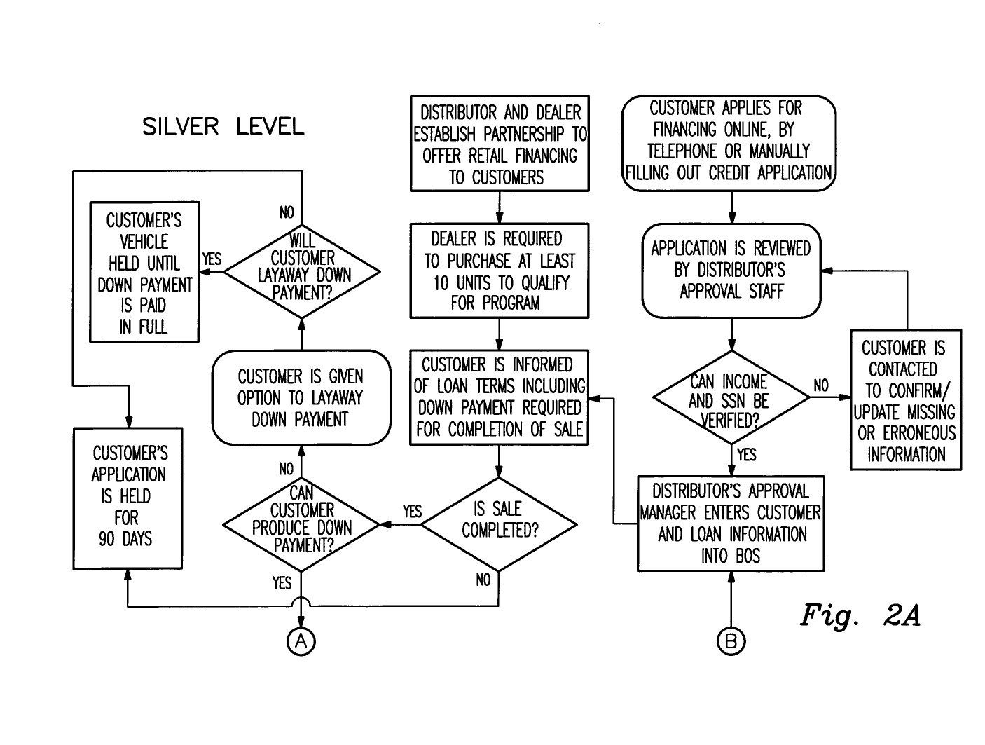

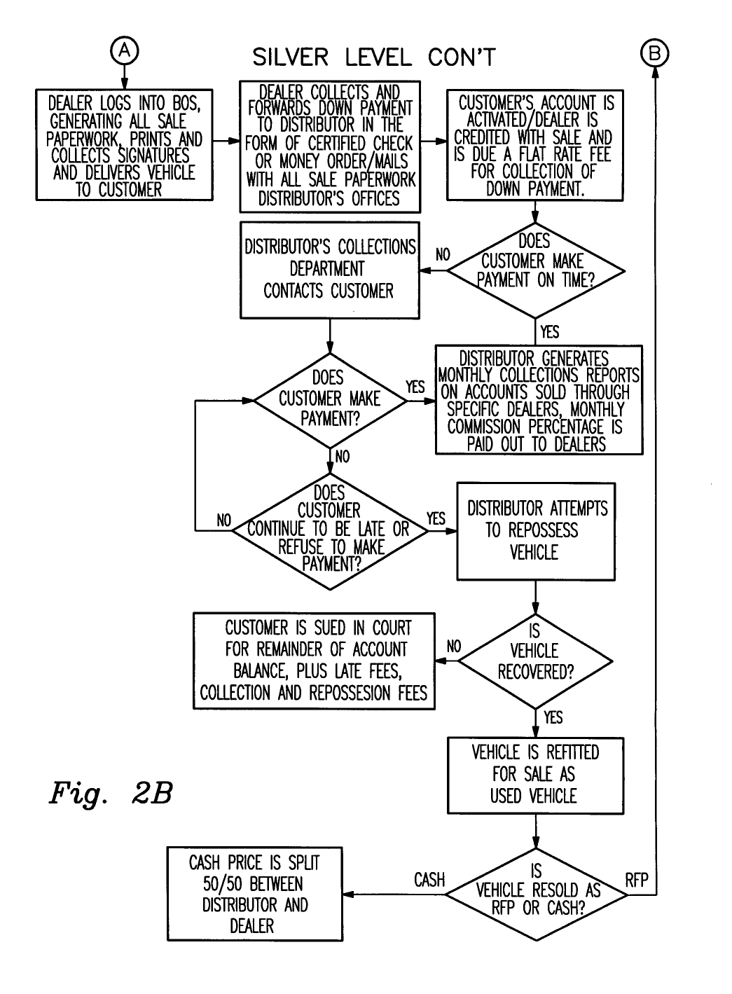

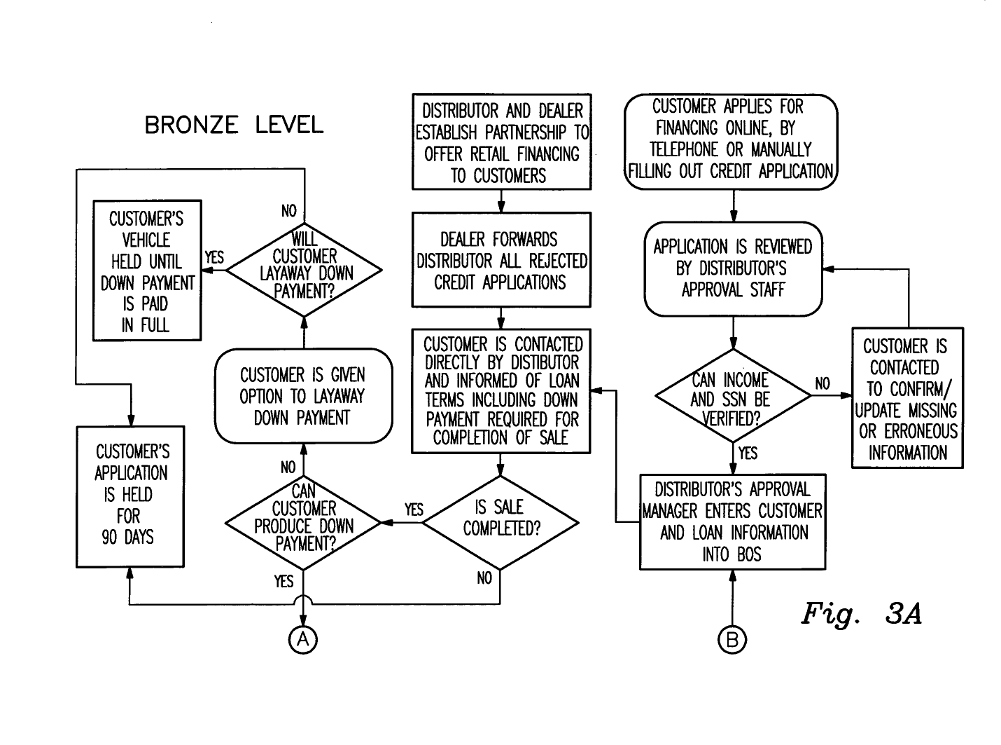

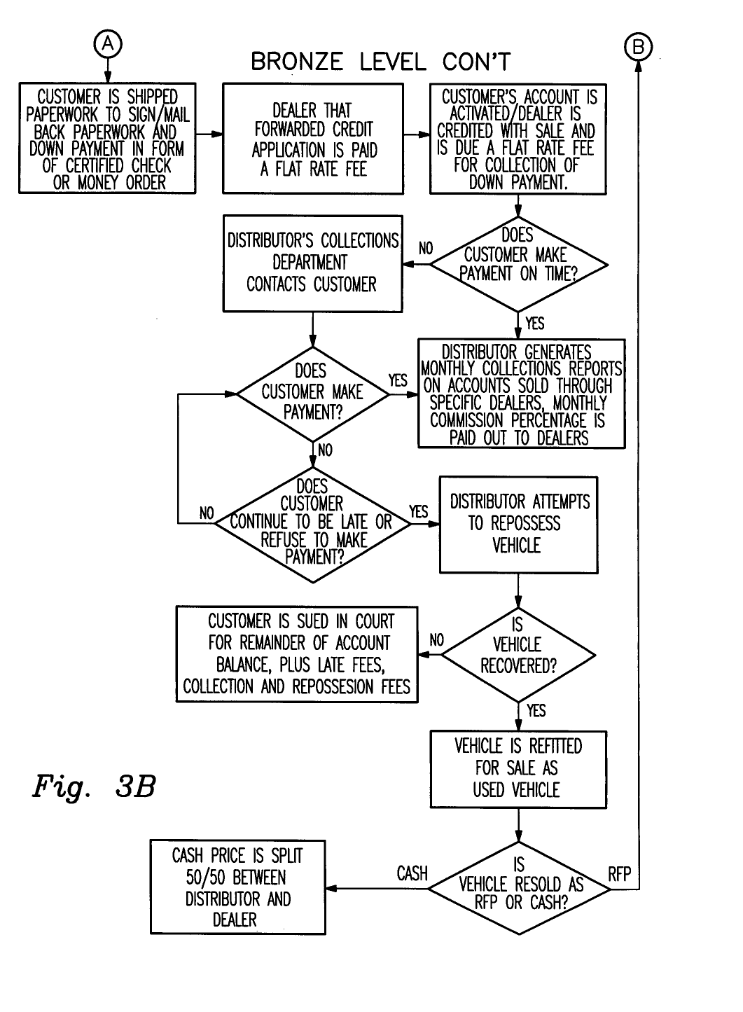

FIGS. 1, 2 and 3 illustrate flow charts representatively showing Gold, Silver and Bronze levels.

In the above description, a distributor provides the financing. A manufacturer, including a manufacturer which sells directly to dealers, may also provide the financing using the methods taught by this invention.

From the foregoing description of one embodiment of the invention, it will be apparent that many modifications may be made therein. It will be understood that this embodiment of the invention is an exemplification of the invention only and that the invention is not limited thereto.

1. A method for retail financing comprising:
a financing entity providing at least one unit to be financed to a retailer;
the retailer collecting information concerning a customer who desires to purchase the unit;
forwarding the information concerning the customer to the financing entity;
preparing financing terms and conditions including down payment and monthly payments;
approving sale of the unit to customer;
collecting down payment for the unit from the customer payable to the financing entity;
executing the financing terms and conditions by the customer;
delivering the unit to customer; and
the financing entity paying the dealer a portion of the down payment and portion of the monthly payments.
